(19) United States
(12) Patent Application Publication
(10) Pub. No.: US 2014/0172393 A1
(43) Pub. Date: Jun. 19, 2014

(54) TRAFFIC COMMUNICATION-INTEGRATED SYSTEM

(71) Applicant: THE KOREA TRANSPORT INSTITUTE, Goyang-si (KR)

(72) Inventors: Yeon-Soo KANG, Goyang-si (KR); Kyeong-Pyo KANG, Seoul (KR); BEOMIL KIM, Goyang-si (KR); Jae-Won LEE, Seoul (KR)

(73) Assignee: THE KOREA TRANSPORT INSTITUTE, Goyang-si (KR)

(21) Appl. No.: 14/105,721

(22) Filed: Dec. 13, 2013

(30) Foreign Application Priority Data
Dec. 13, 2012 (KR) 10-2012-0145482

(51) Int. Cl. G06F 17/50

(52) U.S. Cl. CPC G06F 17/5009
USPC 703/6

(57) ABSTRACT

Provided is a user interface for implementing a traffic communication-integrated simulation based on a vehicle communication system. The traffic communication-integrated system comprises a traffic simulator which performs a traffic simulation and calculates a link passage time of a vehicle; a communication simulator which performs a communication simulation and simulates a communication between a communication between vehicles and a communication between a vehicle and an infrastructure; and a user interface, wherein the user interface includes an interface server which provides a simulation platform interfacing in real time in a synchronous way the traffic simulator and the communication simulator; and a graphic user interface unit which outputs a result of the simulations.

### CROSS REFERENCE

The present application claims the benefit of Korean Patent Application No. 10-2012-0145482 filed in the Korean Intellectual Property Office on Dec. 13, 2012, the entire contents of which are incorporated herein by reference.

### BACKGROUND OF THE INVENTION

1. Field of the Invention

The present invention relates to a technical concept on a user interface technology for a vehicle communication traffic simulation which makes it possible to carry out a traffic simulation and a communication simulation under one integrated environment.

2. Background Art

A ubiquitous traffic system refers to a future traffic system which makes it possible to provide a real time communication between network elements. For this, the ubiquitous traffic system requires a certain traffic distribution control strategy which is different from the conventional intelligent traffic system.

The conventional traffic system, in recent years, advances into a new traffic system which more greatly requires a wireless communication technology as compared with a conventional ITS (Intelligent Transportation System) and which is based on a data transmission and reception between vehicles and between a vehicle and an infrastructure.

The traffic communication-integrated simulator is directed to simulating a communication between the vehicles and between the vehicle and the infrastructure by simulating on a simulator a VANET (Vehicle Ad-hoc Network).

The wireless communication environment in the traffic sector simulator, however, looks impossible, and many of researchers are doing work based on the assumptions on the characteristics of the communication sector.

The way of researching based on the assumptions on the communication sector might deteriorate the quality of the researches because the understanding on the characteristic of the communication sector and the communication environment remains at a low level.

The conventional TraCISS v 1.0 contributes to the development of the traffic communication-integrated simulator of the prototype which may be used based on the scenario that a researcher (or a user) wants to analyze.

The above mentioned TraCISS v 1.0 has implemented a new interface S/W server in such a way to integrate the commercially available simulator and the commercially available simulator of the communication sector by using the shared memory structure, and based on which a simulation based on the VANET environment is made possible.

### SUMMARY OF THE INVENTION

Accordingly, it is an object of the present invention to provide a traffic communication-integrated system, comprising a traffic simulator which performs a traffic simulation and calculates a link passage time of a vehicle; a communication simulator which performs a communication simulation and simulates a communication between a communication between vehicles and a communication between a vehicle and an infrastructure; and a user interface, and the user interface including an interface server which provides a simulation platform interfacing in real time in a synchronous way the traffic simulator and the communication simulator; and a graphic user interface unit which outputs a result of the simulations.

The interface server according to an embodiment of the present invention processes an interface and an integration in a real time synchronous way between the traffic simulator and the communication simulator, and collects a result of the traffic simulation and a result of the communication simulation and processes a data, and processes a protocol with the graphic user interface unit.

The interface server according to an embodiment of the present invention transmits and receives a simulation parameter, a UIS, a UVS update and a user packet and processes an interface and an integration between the traffic simulator and the communication simulator.

The interface server according to an embodiment of the present invention performs an exposed measure environment setup and update, and transmits a corresponding result to the graphic interface unit, and receives a user data from the Paramics software, and transmits to a communication environment of the Qualnet S/W and interfaces for the communication simulation to be performed, and when a communication simulation is finished in the Qualnet software, the data of the completion is transferred to the Paramics software, for thereby processing a traffic communication simulation.

Using the interface server GUI program, the graphic user interface unit according to an embodiment of the present invention sets the traffic communication-integrated simulation and monitors the same in real time, and provides a simulation result process module and a display process module, and provides a traffic/communication input condition setting UI, and provides an integrated simulation result display UI, and controls the operations of the traffic/communication simulator.

According to an embodiment of the present invention, it is possible to provide a simulation platform on which to interface in real time in a synchronous way an interface server (including GUI) of a traffic simulator (Paramics S/W), a communication simulator (Qualnet S/W) and an integrated simulator.

According to an embodiment of the present invention, it is possible to obtain an automated simulation in such a way to add a GUI to an integrated simulator for the sake of a user's convenience.

According to an embodiment of the present invention, thanks to the contribution to the automation of the simulation, it is possible to provide a generalized, integrated simulation environment.

According to an embodiment of the present invention, each of the traffic, communication and integrated simulators can be distributed and installed in personal computers and can be operated a network system.

According to an embodiment of the present invention, it is possible to perform a V2V, V2I communication simulation via an actual 802.11A communication network in such a way to transmit in a packet the VID, position, time and transmission data of a vehicle.

According to an embodiment of the present invention, it is possible for a traffic expert to perform a traffic communication-integrated simulation in such a way to use a 802.11A communication network without using professional knowledge.

According to an embodiment of the present invention, it is possible to implement an integrated simulation on which an environment similar with an actual result obtained in the middle of the traffic operation can be reflected by applying a 802.11A actual communication environment including a weather condition, etc.

According to an embodiment of the present invention, it is possible to provide a universal type traffic communication platform on which to perform a traffic communication simulation by directly using a program (C-computer language).

According to an embodiment of the present invention, a modeling with respect to a 802.11A communication hierarchy and propagation environment can be performed, so a traffic communication simulation to which an actual communication environment is applied can be performed.

### BRIEF DESCRIPTION OF DRAWINGS

FIG. 1 is a block diagram illustrating a traffic communication-integrated simulation system according to an embodiment of the present invention.

FIG. 2 is a view for describing a construction of a traffic communication-integrated Paramics API/Qualnet External Interface.

FIG. 3 is a view for describing a construction of an Interface Server as a sub-program.

FIG. 4 is a view for describing an Interface Server (traffic communication-integrated simulator main GUI).

FIG. 5 is a view for describing an Interface Sever GUI Parameter setting screen.

FIG. 6 is a view for describing a PARAMICS simulation circumference.

FIG. 7 is a view for describing a Qualnet communication simulation circumference.

FIG. 8 is a view for describing a space-synchronized integrated simulator (upper side: Qualnet, lower side: PARAMICS).

FIG. 9 is a view for describing a Qualnet communication simulation screen.

FIG. 10 is a view for describing a traffic communication-integrated simulator.

FIG. 11 is a view for describing a Paramics Interface module construction content-Qualnet external interface and an application layer.

FIG. 12 is a view for describing a program list of a Paramics Interface Module program.

FIG. 13 is a view for describing a transmission and reception routing of a Qualnet interface module.

FIG. 14 is a view for describing a source code program list which is related to a Qualnet Interface Module.

FIG. 15 is a view for describing a Qualnet patch file.

FIG. 16 is a view for describing a program list of an Interface Server.

FIG. 17 is a view for describing an Interface Server GUI main screen.

FIG. 18 is a view for describing a program list of an Interface Server GUI.

FIG. 19 is a view for describing a client launcher screen.

FIG. 20 is a view for describing an integrated simulation setting method and a flow chart.

FIG. 21 is a view for describing an execution file of LauncherClient.exe.

FIG. 22 is a view for describing a Launcher Client setting screen.

FIG. 23 is a view for describing an execution file of PQInterfaceServerUI.exe.

FIG. 24 is a view for describing a traffic communication simulator main UI.

FIG. 25 is a view for describing a Qualnet S/W call-in screen.

FIG. 26 is a view for describing a scenario setting screen on which the next Qualnet IDE is called in after an OK button is clicked.

FIG. 27 is a view for describing a Qualnet scenario file loading screen.

FIG. 28 is a view for describing a scenario execution screen using a Qualnet consol mode.

FIG. 29 is a view for describing an execution screen of a Qualnet scenario file.

FIG. 30 is a view for describing a scenario execution file.

FIG. 31 is a view for describing a call-in screen of Paramics.

FIGS. 32 and 32 are views for describing a network file loading screen in Paramics modeler.

FIG. 34 is a view illustrating a screen on which a simulation configuration is set.

FIG. 35 is a view for describing an integrated simulator RUN screen.

FIG. 36 is a view illustrating an integrated simulator network file setting.

### DETAILED DESCRIPTION OF THE INVENTION

The preferred embodiments of the present invention will be described with reference to the accompanying drawings.

In the middle of the description of the present invention, if it is judged that part of the known function or construction might make unclear the subject matter of the present invention, the description thereon will be omitted. The terminology used in the present invention are used so as to describe a preferred embodiment of the present invention; however such terminology might be differently defined depending on the user's or operator's intention or the practices of the field that the present invention belongs to. Therefore, the definitions on such terminology should be interpreted based on the contents throughout the specification. The same reference numerals as shown in each drawing represent same elements.

The present invention was commenced along with a development demand on the traffic communication-integrated simulator which can overcome the limits in many researchers.

The present invention has features in that the function of the conventional system can be enhanced, and the simulation platform can be fully changed, so a traffic communication-integrated network simulation environment of a real time synchronous way can be obtained. The user can easily use the integrated simulation by adding a UI (User Interface) of the integrated simulator, and a result of the simulation can be provided in a graphic form.

The present invention makes it possible to provide a generalized traffic communication-integrated simulator, so a traffic expert who does not have professional knowledge can easily use.

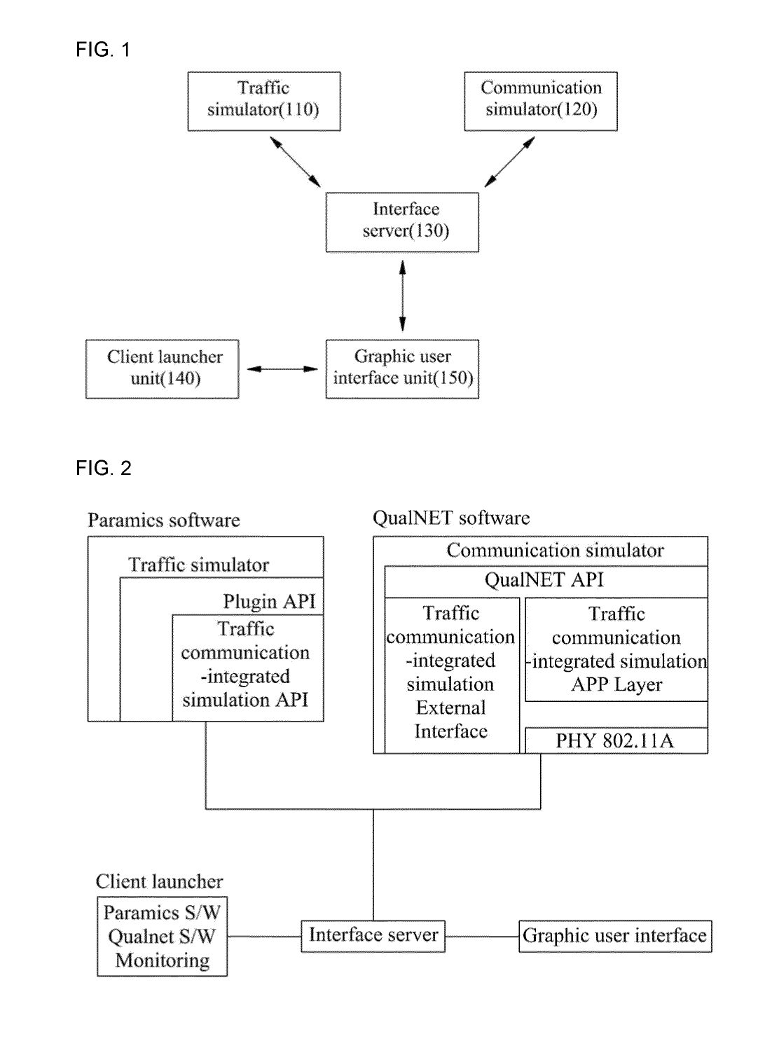

FIG. 1 is a block diagram illustrating a traffic communication-integrated simulation system according to an embodiment of the present invention.

The traffic communication-integrated simulation system 100 according to an embodiment of the present invention allows a traffic expert who has a Paramics S/W (traffic simulator S/W) and a Qualnet S/W (communication network simulator) to implement a traffic simulation in consideration of communications.

For thus, each entity can use a communication protocol of 802.11A, and can also use a 802.11A communication library of Qualnet S/W as a model with respect to a propagation environment and a communication layer.

The traffic communication-integrated simulation system 100 according to an embodiment of the present invention supports a Paramics Interface module in a type of SDK (Software Development Kit) for a traffic expert to complete a C-computer language-based universal traffic scenario program in a plug-in form by using API of a Paramics S/W and to use the same for the sake of a communication environment. The traffic communication simulation can be performed based on a Qualnet communication environment through the interface server.

In other words, the traffic communication-integrated simulation system 100 makes it possible to obtain a traffic simulation without a professional knowledge on the communication.

Each module belonging to the traffic communication-integrated simulation system 100 according to an embodiment of the present invention has a transmission and reception structure which uses a synchronization way in which the data between the Paramics S/W, the Qualnet S/W and the Interface Server can be transmitted in real time in such a way to transmit each data to the TCP for the sake of the network simulations.

The traffic communication-integrated simulation system 100 comprises a user interface.

The user interface of the present invention comprises at least one of an interface server 130 and a graphic user interface unit 150.

The traffic communication-integrated simulation system 100 is in compliance with the functional restrictions of the Paramics S/W and the Qualnet S/W, and a result of the analysis of the simulation can be seen through the user interface which is formed of the Paramics S/W and the Qualnet S/W and the GUI.

For the enhanced efficiency of the simulation, the user interface may be formed in a stand-along form as well as an engine structure of the traffic simulator for the sake of a network simulation.

According to the traffic communication-integrated simulation system 100 which comprises the user interface, there may be provided a simulation platform which interfaces in real time in a synchronous way the Interface Server (including GUI) of the traffic simulator (Paramics S/W), the communication simulator (Qualnet S/W) and the integrated simulator.

According to the traffic communication-integrated simulation system 100 which comprises the user interface, the simulation can be automated in such a way to add the GUI to the integrated simulator for the sake of a user's convenience.

According to the traffic communication-integrated simulation system 100 which comprises the user interface, a generalized, integrated simulation environment can be obtained thanks to the automated simulation.

The traffic communication-integrated simulation system 100 according to an embodiment of the present invention comprises a traffic simulator 110, a communication simulator 120, an interface server 130, a client launching unit 140 and a graphic user interface unit 150.

The traffic communication-integrated simulation system 100 according to an embodiment of the present invention has features in that a link passage time of vehicles can be calculated based on the traffic simulation.

The traffic simulator 110 is capable of calculating a link passage time using the information between the vehicles which have succeeded in communication as a result of the communication simulation.

The traffic simulator 110 is capable of calculating a link passage time based on the selected cycle.

The traffic simulator 110 can perform a traffic simulation by determining at least one of a simulation time, a vehicle identification information, a vehicle position information and a data size.

Using the Paramics interface module program, the traffic simulator 110 provides an External Interface and Application Layer module so as to provide V2V, V2I communication simulations and maps the UVS vehicle on the Paramics and the UIS device based on the 802.11A communication Node on the Qualnet and processes the UVS/UIS transmission/reception packet simulation module.

At least one of the traffic simulator 110, the traffic simulator 120 and the user interfaces 130 and 150 can provide a traffic communication-integrated simulation environment in organic cooperation with a plurality of sub programs.

The communication simulator 120 according to an embodiment of the present invention performs a communication simulation for thereby simulating the communication between the vehicles and the communication between the vehicle and the infrastructure.

Using the Qualnet interface module program, the communication simulator 120 provides an Engine and a Plug-in API so as to provide V2V, V2I communication simulations and collects the results of the traffic simulations and provides a UIS process module, a UVS process module, a UIS/UVS transmission/reception simulation API.

The interface server 130 according to an embodiment of the present invention provides a simulation platform which interfaces in real time with the traffic simulator with respect to the communication simulator.

Using the interface server program, the interface server 130 according to an embodiment of the present invention processes an interface and an integration between the traffic simulator and the communication simulator and collects the results of the traffic simulation and the communication simulation and processes the data and the protocols with the graphic user interface.

The interface server 130 according to an embodiment of the present invention transmits and receives a simulation parameter, a UIS, UVS update and a user packet and interfaces and integrates the traffic simulator and the communication simulator.

The interface server 130 according to an embodiment of the present invention performs an exposed measure environment setup and an update and transmits a result of the same to the graphic user interface and receives a user data from the Paramics software and transmits to the communication environment of the Qualnet S/W and interfaces for the sake of a communication simulation. When the communication simulation is completed, the data is transferred to the Paramics software for thereby processing a traffic communication simulation.

Using the client launcher program, the client launcher unit 140 according to an embodiment of the present invention sets the positions of the Qualnet S/W and the Paramics S/W license and checks the connection state of the Qualnet S/W and the Paramics S/W and performs a network environment setting.

The graphic user interface 150 according to an embodiment of the present invention can output a result of the simulation.

The traffic communication-integrated simulation system 100 can perform a V2V, V2I communication simulation through the actual 802.11A communication network by transmitting the VID, position, time and transmission data of the vehicle to the packet.

Therefore, the traffic expert can perform a traffic communication-integrated simulation using the 802.11A communication network environment without having professional knowledge.

The conventional TraCISS v1.0 simulator interfaces with the traffic and communication simulators in such a way to use the shared memory in one PC environment (Paramics S/W), whereas the traffic communication-integrated simulation system 100 according to the present invention is configured in a simulation platform structure which can interface in real time in a synchronous way the traffic simulator 110 (Paramics S/W), the communication simulator 120 (Qualnet S/W), the interface server 130, the client launcher unit 140 and the graphic user interface unit 150.

The traffic communication-integrated simulation system 100 makes it possible to build up a generalized, integrated simulation environment, and to implement the interface module in the form of the SDK (Software Development Kit) and the source code for each simulator to be synchronized.

Each traffic, communication-integrated simulator can be distributed, and can be installed in each PC and can be operated by way of a network, for thereby enhancing the simulation efficiency and the capacity.

The traffic communication-integrated simulation system 100 applies the 802.11A actual communication environment including the weather condition to the simulation for thereby implementing an integrated simulation to which the environment similar with the actual result obtained from the traffic operation is applied.

For the sake of a user's convenience, the integrated simulator comprises a GUI, which enhances the automation of the simulation.

The traffic communication-integrated simulation system 100 provides the Paramics S/W (traffic simulator) with the Qualnet S/W (communication simulator) communication environment, for thereby providing a universal traffic communication simulation platform which can perform the traffic communication simulations by directly using the traffic network scenario program (C-computer language) of the traffic expert.

The traffic communication-integrated simulation system 100 makes it possible to provide a modeling with respect to the 802.11A communication hierarchy and propagation environment, for thereby performing the traffic communication simulation to which the actual communication environment is applied.

FIG. 2 is a view for describing the construction of the traffic communication-integrated Paramics API/Qualnet External Interface.

As shown therein, the traffic communication-integrated simulation system may comprise five interface modules which are implemented by five sub programs.

FIG. 2 shows an organic function of each interface module including the Paramics S/W, Qualnet external interface, etc.

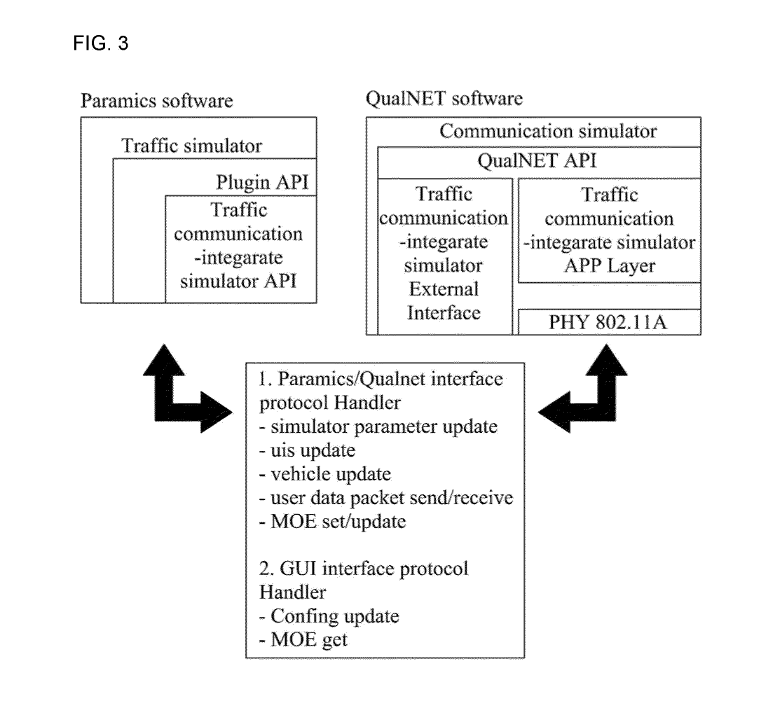

FIG. 3 is a view for describing the construction of the Interface Server as the sub program.

FIG. 3 shows the portions corresponding to the functions of the interface server which is the key part of the five interface modules of the traffic communication-integrated simulation system.

The interface server comprises a function of transmitting and receiving a simulation parameter, a UIS, a UVS update and a user packet and a function of performing a measure environment setup exposed to the interface server and an update and transmitting a corresponding result to the GUI.

In addition, the interface server comprises a function of receiving a user data which was received from the Paramics S/W of the traffic simulator and transmitting to the communication environment of the Qualnet S/W of the communication simulator for thereby performing an interface for the sake of a communication simulation.

When the Qualnet S/W completes a communication simulation, the data are transmitted back to the Paramics S/W for thereby completing the traffic communication simulation.

Each interface between the Paramics S/W, the Qualnet S/W, the interface server and the GUI can transmit and receive a corresponding data based on the TCP real time communication.

The links between the interface modules of each traffic communication-integrated simulator are connected in real time, and can be implemented for the real time simulation to be performed in the synchronous way.

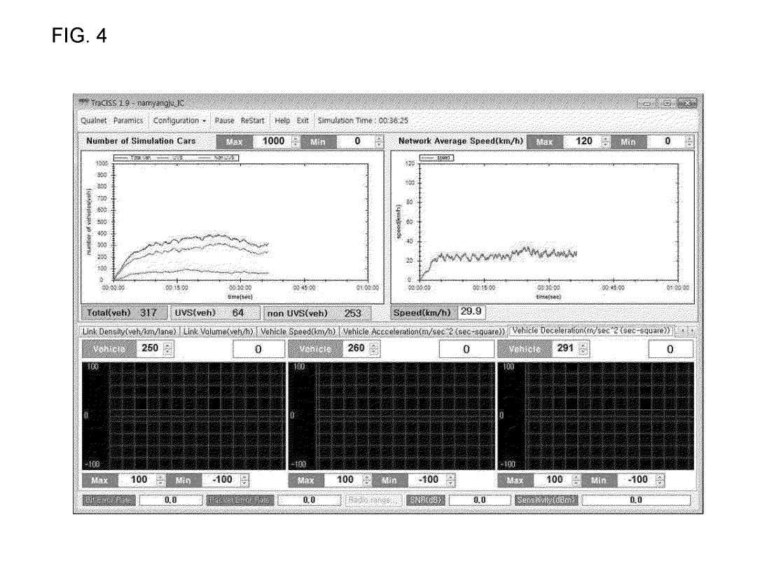

FIG. 4 is a view for describing the Interface Server GUI (traffic communication-integrated simulator main GUI).

FIG. 4 is a view illustrating a construction screen of an Interface Server GUI that the graphic user interface provides. The menu icons such as “Qualnet”, “Paramics” and “Configuration” positioned at the left upper side of FIG. 4 can be interpreted as the setup parameters for the sake of the traffic communication-integrated simulation.

When the icon “Qualnet” is clicked, the Qualnet S/W, which is the communication simulator, is called in, and the 802.11A communication scenario file for performing a corresponding simulation is selected and loaded.

When the icon “Paramics” is clicked, the Paramics S/W, which is the traffic simulator, is called in, and a corresponding network file can be loaded.

The icon “Configuration” is used when setting the UVS, UI transmission power, data rate.

When the icon “RUN” by the icon “Configuration” is clicked, the integration simulation is performed, and the icon “Pause” can be generated, and the icons “Pause”, “Restart” and “Exit” are used when stopping and restarting the routine and are used when performing the simulator exit function.

The icon “Help” is used when calling in the user manual, and the icon “simulation time” is used when indicating the integrated simulation execution time.

Two graphs of the upper portion and three graphs of the middle portion of FIG. 4 represent a result of the traffic simulations in the integrated simulation results, and the Paramics S/W traffic simulation results can be indicated in real time on the GUI through the Interface Server.

In each traffic simulation graph, the display environment can be directly set by the user, and “Bit Error Rate”, “Packet Error Rate”, “SNR” and “Sensitivity” can display a result of the communication simulation.

“Radio Range” can provide a function of displaying the communication radius under the Qualnet S/W environment in the middle of the integrated simulation.

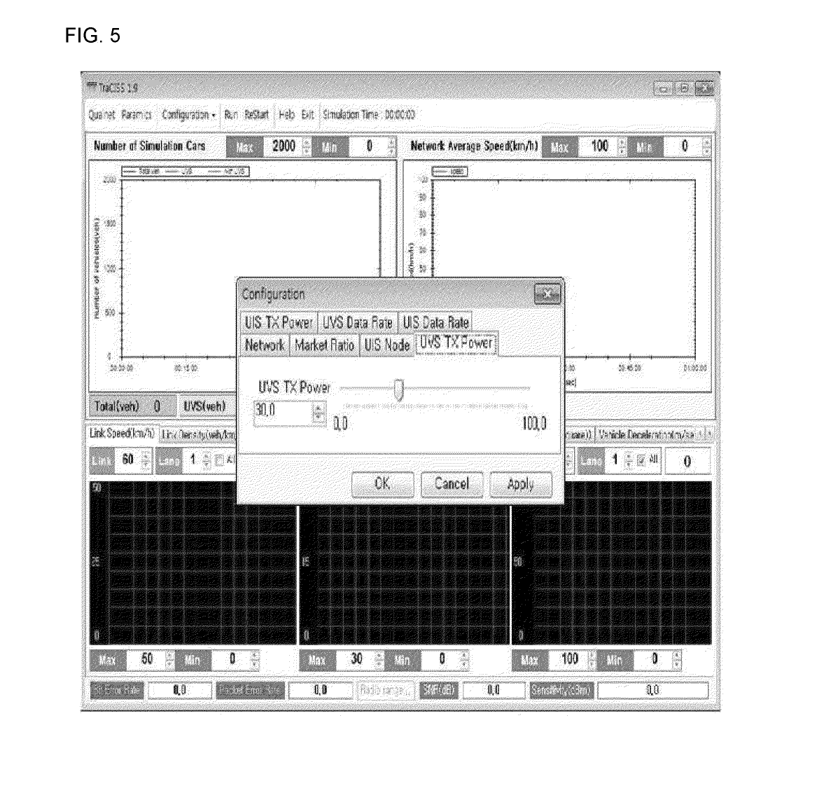

FIG. 5 is a view for describing the Interface Server GUI Parameter setting screen.

The following image (FIG. 5) can show a configuration that each simulation setting parameter is inputted under the GUI environment.

For the Market Ratio, the ratio of the communication possible vehicle among the whole vehicles which can be equipped with the UVS terminal can be inputted in a range of 0 to 100%, and TX power helps input a desired transmission power. Data Rate helps select the Data rate stimulated in 802.11A.

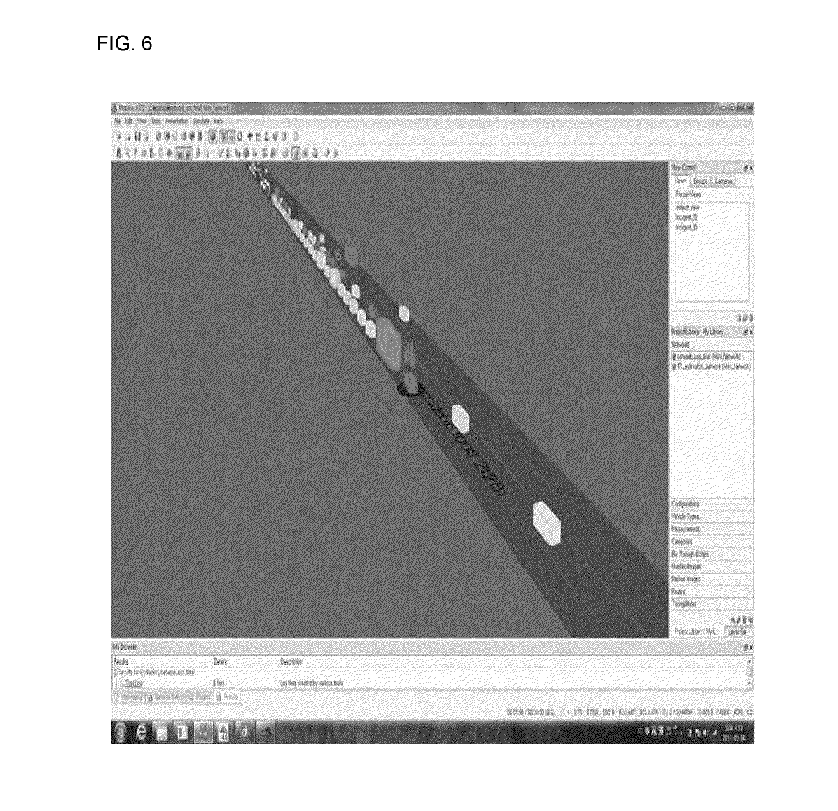

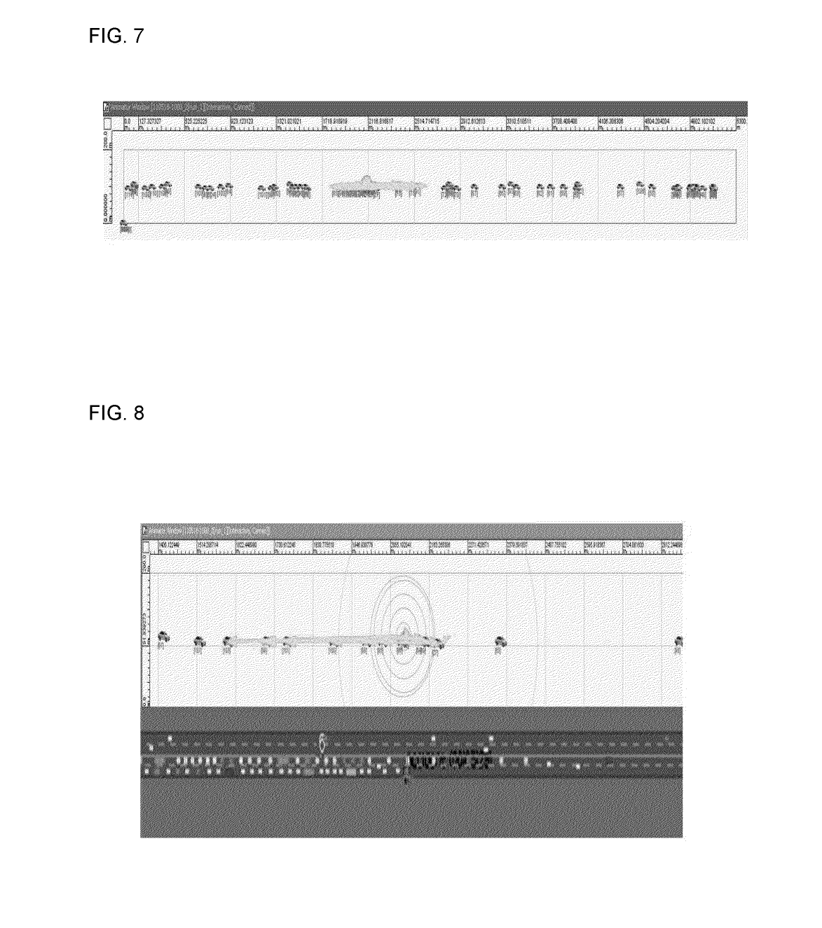

FIG. 6 is a view for describing a PARAMICS simulation circumference, and FIG. 7 is a view for describing a Qualnet communication circumference.

The operations of the actual traffic communication-integrated simulators will be described as follows.

In the PARAMICS which is a traffic sector simulator, an actual traffic circumference can be implemented by simulating the types of the individual vehicles.

In the QualNet which is a communication sector simulator, the communication environment is implemented based on the vehicle information of PARAMICS.

The transmission and reception with respect to PARAMICS and Qualnet S/W through the Interface Server are implemented; by means of which the traffic communication simulation is performed. FIGS. 6 and 7 show the PARAMICS and Qualnet simulation circumferences.

FIG. 8 is a view for describing a space-synchronized integrated simulator (upper side: Qualnet, lower side: PARAMICS).

The traffic communication-integrated system according to the present invention provides an integrated simulator by time and space synchronizing the PARAMICS and the QualNet, and it is possible to obtained the simulator which is space synchronized.

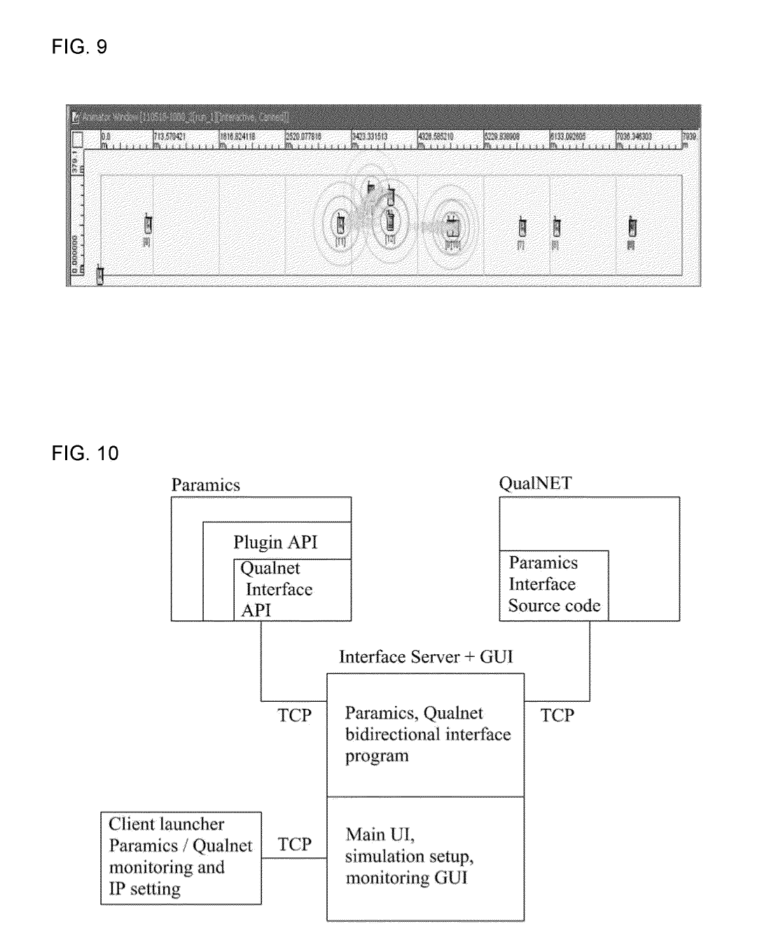

FIG. 9 is a view for describing the Qualnet communication simulation screen.

The traffic communication-integrated simulation system receives a position, time, VID, data packet information of each vehicle from the Paramics S/W and transfers to the Qualnet through the interface server for thereby synchronizing the time and position.

In the middle of the operations of the traffic communication-integrated simulation system, an animation function can be performed so as to check the movement and communication states of the communication vehicle thanks to the Qualnet S/W. As shown in FIG. 9, the circular portion indicates a transmission state, and the green color portion indicates a communication state.

FIG. 10 is a view for describing a construction of a traffic communication-integrated simulator.

The traffic communication-integrated simulator is formed of five Interface Modules which are operated by five sub programs. The traffic communication-integrated simulation environment is implemented as five sub programs organically operate.

Since the direct interface between the Paramics S/W which is the traffic simulator and the Qualnet S/W which is the communication simulator is impossible, the transmission and reception interface environment for the sake of an interoperation between the Paramics traffic S/W and the Qualnet communication S/W can be obtained.

The traffic communication simulation is performed based on 802.11A communication environment of the Qualnet S/W by transmitting the user data defined in the Paramics S/W to the Qualnet S/W. A result of the communication simulation based on the Qualnet S/W can be transmitted to the Paramics S/W through the interface server.

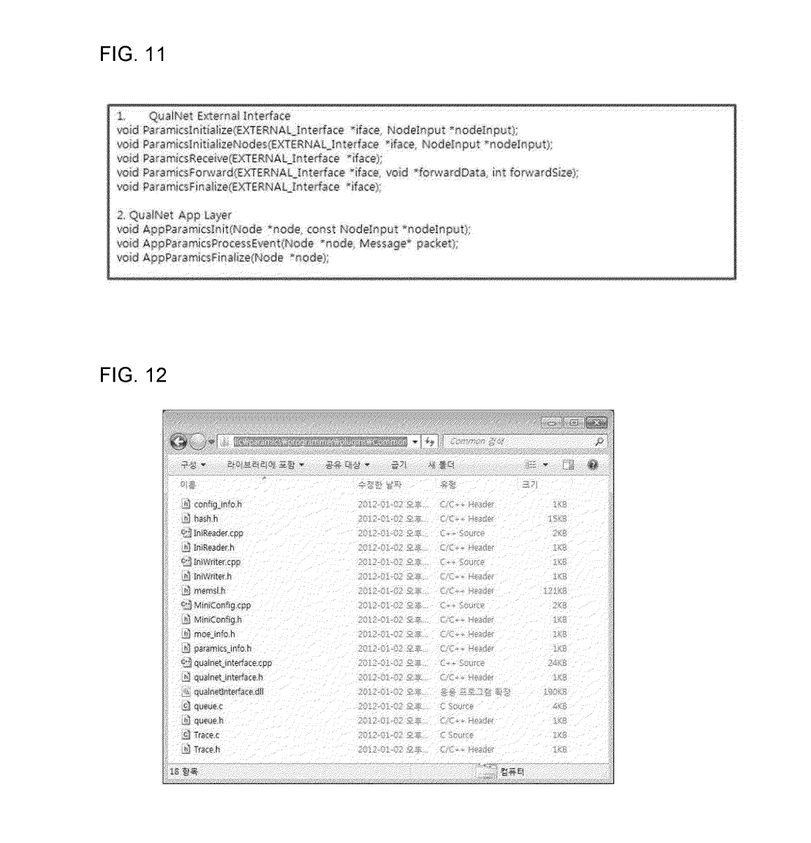

FIG. 11 is a view for describing a Paramics Interface module construction content-Qualnet external interface and an application layer.

The traffic communication-integrated simulator may be equipped with an External Interface and an Application Layer module for providing the Qualnet S/W with the V2V, V2I communication simulation and a new Paramics S/W for the Qualnet S/W Interface for the sake of the conventional Paramics S/W external API, which are developed in the form of library.

For the future use, the library related to the Paramics interface module can be saved in C:/Users/Public/paramics/programmer/plugins/common/qualnetInterface.dll.

There may be provided an API for a traffic communication-integrated simulation with which to easily simulate the traffic scenario of the traffic expert based on the C-computer language.

FIG. 12 is a view for describing a program list of a Paramics Interface Module program.

As shown in FIG. 12, the traffic communication-integrated simulator can show the program list of the Paramics Interface Module by using the program list of the Paramics Interface Module.

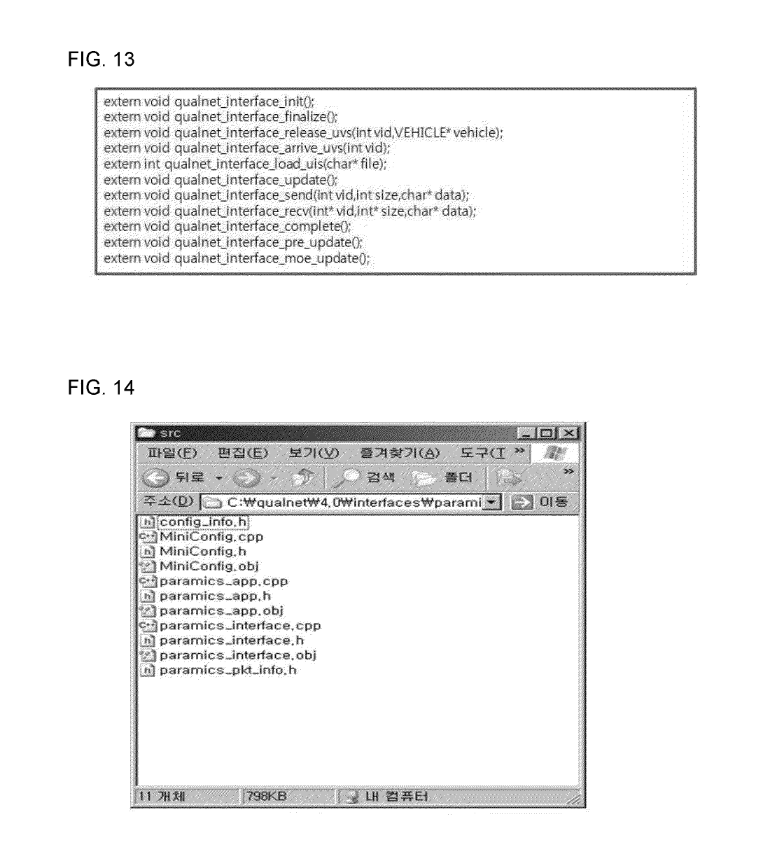

FIG. 13 is a view for describing a transmission and reception routing of a Qualnet interface module.

The traffic communication-integrated simulator can simulate in the console mode the engine for providing the Paramics S/W with the V2V, V2I communication simulation, the interface module which provides the plug-in API and the animation of the Qualnet S/W.

The basic setup and execution file of the Qualnet interface module are provided as a default files, and for the future use, the program (paramics_interface.cpp) for interfacing the Paramics S/W can be saved in C:/qualnet/4.0/interfaces/paramics/scr.

If a traffic developer wants a traffic communication simulation in a new communication method, it is possible to refer to a process which is designed to build a new communication-related simulation setup and an execution file of the Qualnet simulator.

FIG. 14 is a view for describing a source code program list which is related to a Qualnet Interface Module.

As shown in FIG. 4, it is possible to check the Qualnet Interface Module-related source code program list.

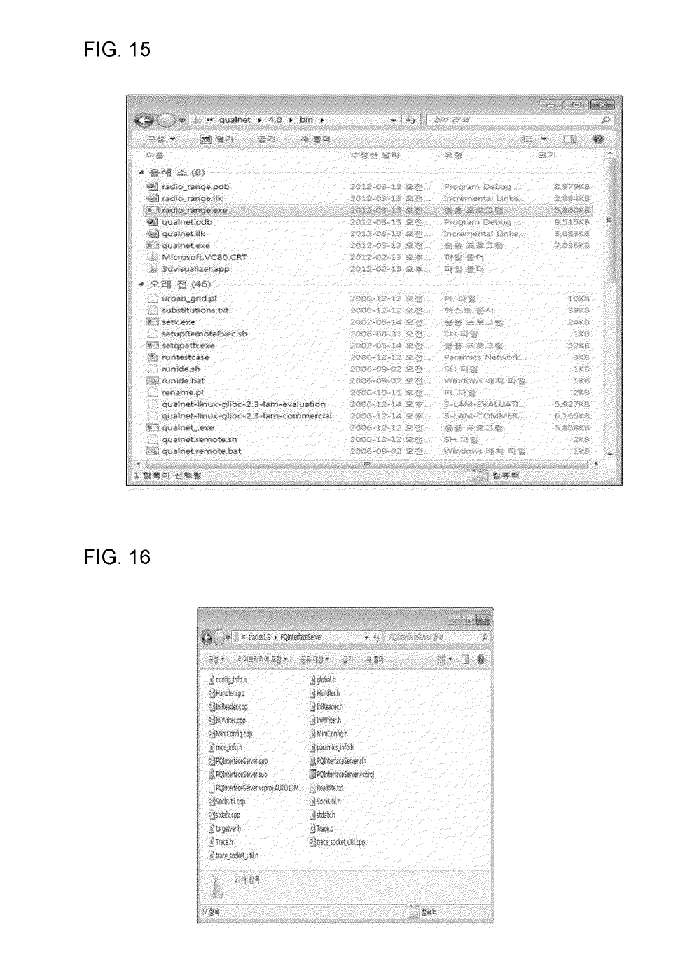

FIG. 15 is a view for describing a Qualnet patch file.

FIG. 15 shows a Qualnet traffic communication-integrated simulator patch installation file. For the future use, the following two files in the file fold can be saved in C:/qualnet/4.0/bin.

The traffic communication-integrated simulator according to an embodiment of the present invention can provide a basic scenario with respect to the communication environment since a communication inexpert provides an environment for performing a traffic/communication simulation.

The communication scenarios which are basically provided are as follows.

Each communication scenario can be seen in the scenario files in the four folders at C:/qualnet/4.0/scenarios.

Node1000.config (C:/qualnet/4.0/scenarios/Node1000)

: 802.11A communication method adapted. The frequency/TX power/Data Rate helps set the automatic setting (Auto callback —yes) and the manual setting (Auto callback—no). The communication simulation environment can be set with respect to 1,000 nodes.
Node1000_weather.config (C:/qualnet/4.0/scenarios/Node1000_weather)

: The communication simulation environment in consideration of the same environment of Node1000.config+the rainfall.
Node3000.config (C:/qualnet/4.0/scenarios/Node3000)

802.11A communication method adapted. The frequency/TX power/Data Rate helps set the automatic setting (Auto callback —yes) and the manual setting (Auto callback—no). The communication simulation environment can be set with respect to 3,000 nodes. The nodes of over 10,000 can operate only in the Qualnet console mode.
Node3000_weather.config (C:/qualnet/4.0/scenarios/Node3000_weather)

: The communication simulation environment in consideration of the same environment of Node3000.config+the rainfall.

In order to change the number of the nodes of the traffic communication simulation and the protocol, the number of the nodes of the Qualnet example scenarios and the protocol are changed and saved, and the compiling can be performed as follows in the Qualnet consol mode.

The compiling can be performed using the command “nmake” in C:/qualnet/4.0/main folder.

The interface server can be interpreted as a server which interfaces between the traffic simulator and the communication simulator.

The execution file related to the installation of the interface server can be set in C:/traciss/pqinterfaceserver.exe.

The interface server is an interface server to which the C++ computer language-programmed communication network protocol and is formed in a TCP transmission and reception structure so as to provide a bidirectional interface with the Paramics S/W and the Qualnet S/W.

Since the simulation environment can support in the form of both the stand lone and the network, it is more effective than TraCISS 1.0 of the shared memory method, so the simulation with respect to more vehicle nodes is possible.

The messaging type of the interface server is shown in Table 1.

TABLE 1

| MSG_ID | Function |
|---|---|
| 01 | UVS position update |
| 02 | User data packet send |
| 03 | User data packet receive |
| 04 | UIS INFO update |
| 05 | Config update |
| 06 | Paramics parameter update |
| 07 | MOE update |

FIG. 16 is a view for describing a program list of an Interface Server.

As shown in FIG. 16, the program list of the interface server can be checked, and the major functions of the interface server are as follows.
Paramics/Qualnet interface protocol handler
simulator parameter update
uis update
vehicle update
user data packet transmission/reception
simulation set/result update

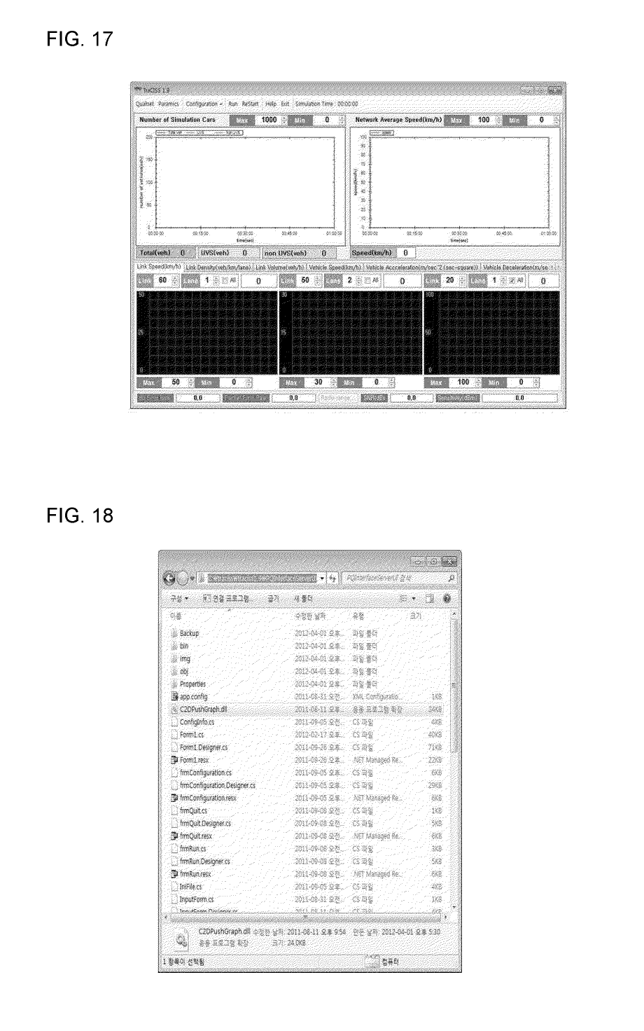

FIG. 17 is a view for describing an Interface Server GUI main screen.

The graphic user interface is used, and the traffic communication-integrated simulator is set, and a real time monitoring is available.

For the future use, the program of the graphic user interface may be saved in C:/traciss/PQinterfacegUI.exe.

The graphic user interface is formed in a graphic user interface structure in which a user can directly modify and use the data of the simulation result graph. FIG. 17 shows the construction of the screen.

The key functions of the graphic user interface are as follows.
Interface Protocol Handler
Simulation Parameter Setting
Configuration Update
Traffic Analysis Result Collection

Traffic Analysis Result Collection

Paramics S/W, Qualnet S/W call-in

Simulator Execution control

FIG. 18 shows the program list of the interface server GUI.

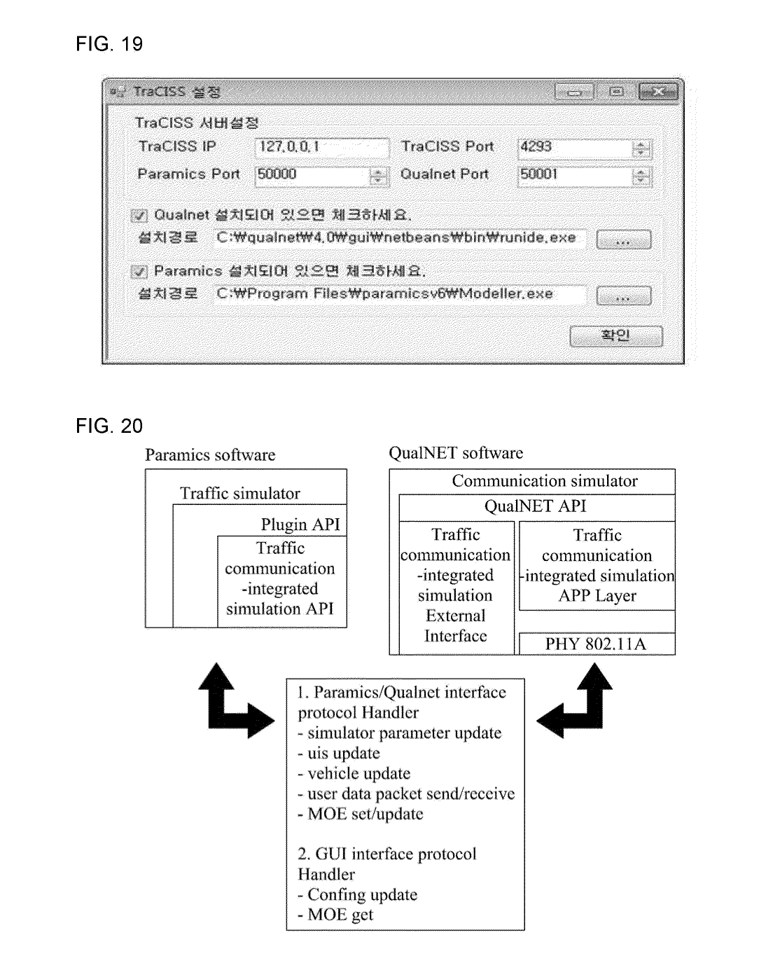

FIG. 19 is a view for describing a client launcher screen.

The client launcher helps setup and monitor the Paramics S/W and the Qualnet S/W on the traffic communication-integrated simulator.

With the client launcher, it is possible to check the connection state of the Paramics S/W and the Qualnet S/W and to set the position of each S/W license, and each Interface module of the integrated simulator can be used as a stand-alone (all installed in one PC) or the IP setting and port setting can be managed for the use on the network.

FIG. 20 is a view for describing an integrated simulation setting method and a flow chart.

As shown in FIG. 20, it is possible to check out the flows with respect to a previous preparation step, a setting and simulation procedure for the sake of a traffic communication simulation.

The following three steps are performed for the traffic communication simulation.

Step 1: Preparations before the use of the traffic communication-integrated simulator

1. Paramics S/W installation

2. Qualnet S/W installation

3. qualnet Interface.dll installation

4. Interface Server.exe installation

5. Interface Server GUI installation

6. Paramics basic setting file installation

7. Qualnet basic setting file installation

Step 2. Simulation Setting Method

Paramics: The known setting method of the paramics is used, and the following items are added.

The UIS nod is included in the nodes-uis file.

But, the UIS node should be over 50000.

File Example)

uis-node 50000-271.6 1767.9 0.0

One should be described in one line as much as it needs.

Format)

“uis-node” <tab><vid><tab><x><tab><y><tab>

“uis-node”: The first field should begin with uis-node.

<tap>: The tab should be used between the fields.

Vid: The vehicle ID on the paramics of the uis node. The terrain that doesn't overlap with the basic vehicle ID should be used.

Notes: In the Qualnet, the communication simulation target should be expressed with the nodes like the UVS-mounted vehicle or the UIS.

It should be noted that it is different from the node of the Paramics. (x, y, z: UIS coordinates on the traffic network)

Qualnet: It is used like the known setting method of the qualnet.
The size setting of the test terrain: It is set in the Qualnet scenario file.

### Example

### Node1000.config

TERRAIN-DIMENSIONS (5300, 1000)
TX Power and Data rate setting: The setting automatic or manual is selected in Qualnet scenario file.

### Example

### Node1000.config

Automatic selection (PHY802.11-AUTO-RATE-FALLBACK: YES)

Manual selection (PHY802.11-AUTO-RATE-FALLBACK: NO)

Node-setting: It is designated in the setting Qualnet scenario file with respect to the concurrent communication Node.

Step 3: Simulation Method and Procedure

1. LauncherClient.exe is executed.

2. PQlntefaceServerUI.exe is executed.

3. The Qualnet S/W is called in from the Main UI, and the IDE is executed, and the basic setting files (scenario files) are loaded, and the scenarios are executed.

4. The Paramics modeler is called in from the Main UI, and the basic setting files (network files) are loaded.

5. Configuration Setting (main UI): setting values are inputted.

6. RUN (main UI)

7. Simulation starts

8. Simulation ends

When the scenario setting file is prepared, the following procedures are performed in order to start the simulations.

First of all, the client launcher is executed, and the PQinterfaceserver/UI is executed, and the Qualnet S/W call-in and scenario files are loaded.

Next, the programs are executed in the following sequence. The Paramics network files are loaded, and the simulation configuration is set, and the integrated simulator RUN is executed.

(1) Client Launcher is Executed.

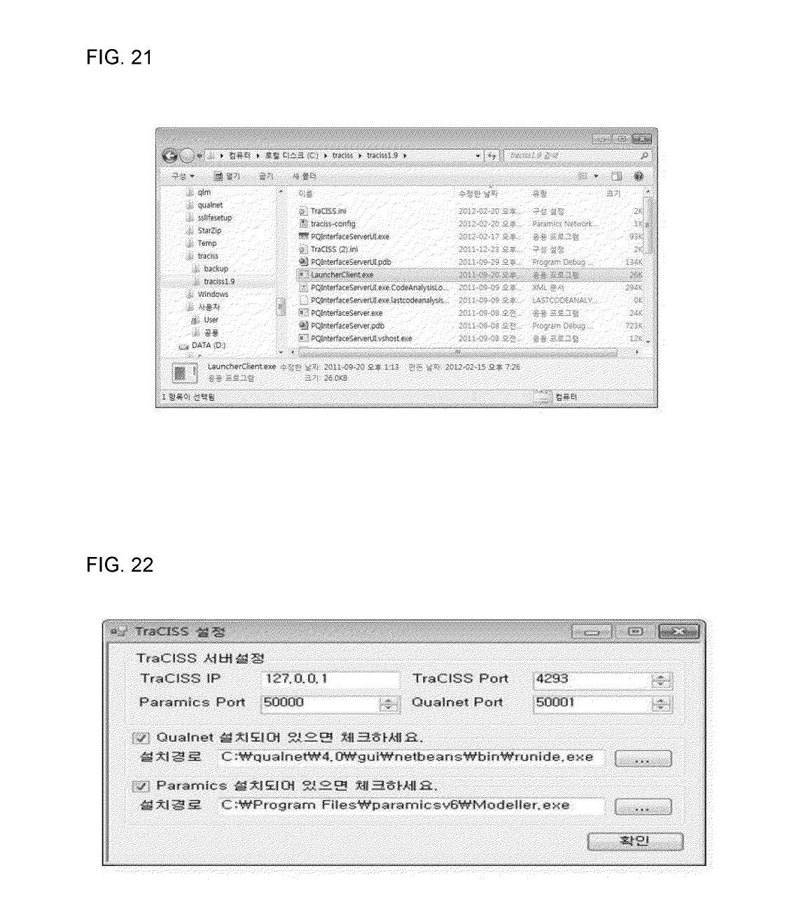

As shown in FIG. 21, the execution file of LauncherClint.exe can be executed on C:/traciss/traciss1.9.

Next, as shown in FIG. 22, the client launcher can be set.

(2) PQ Interface Server is Executed.

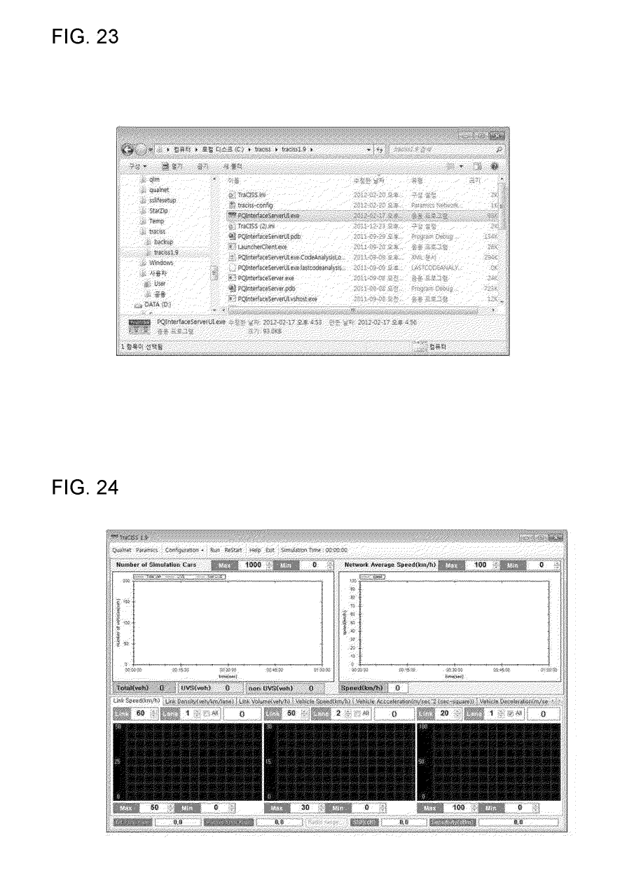

As shown in FIG. 23, the PQ Interface Server can be executed.

As shown in FIG. 23, when PQInterfaceServerUI.exe below C:/traciss/traciss1.9 is executed, the UI and the PQInterfaceserver are executed, and PQInterfaceServerUI.exe is directly accessible on the wallpaper screen.

When PQInterfaceServerUI.exe in the folder of FIG. 23 is double clicked, the server program which is executed on the console window of PQInterfaceServer.exe can be driven.

When PQInterfaceServer.exe is executed without taking other actions, the server program consol window is displayed, and the screen of the main UI as shown in FIG. 24 can be displayed.

(3) Qualnet S/W Call-in and Scenario File Loading

When the Qualnet button of the upper side on the main UI of the traffic communication simulator of FIG. 24 is clicked, the screen on which to set Qualnet can be displayed.

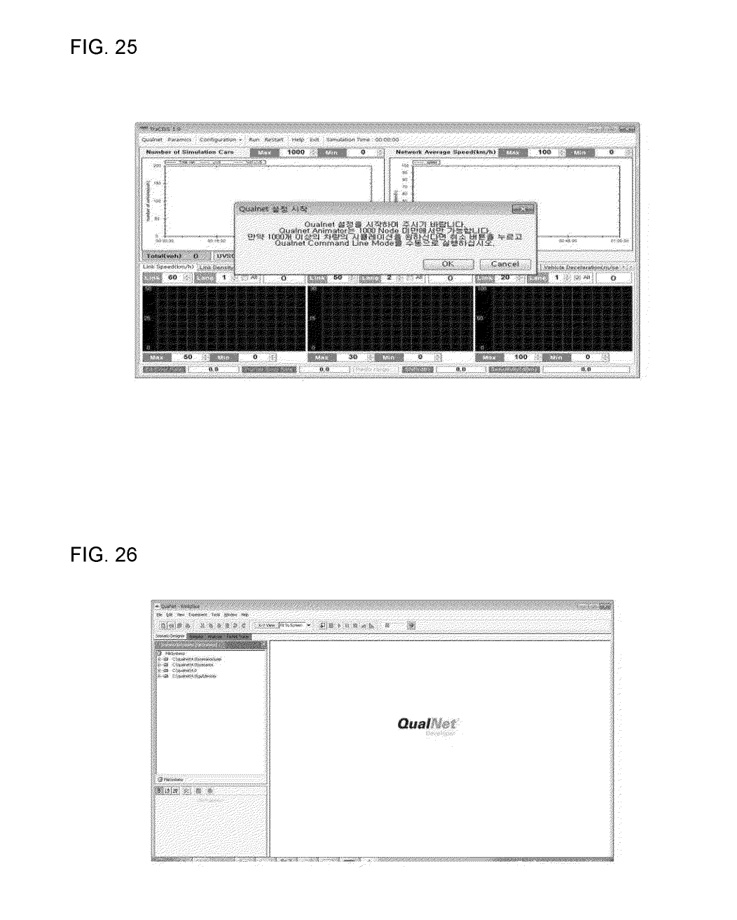

As shown in FIG. 25, the screen on which to call in Qualnet S/W can be displayed.

As shown in FIG. 26, when the OK button is clicked, the Qualnet IDE is called in, and the scenario setting screen can be displayed.

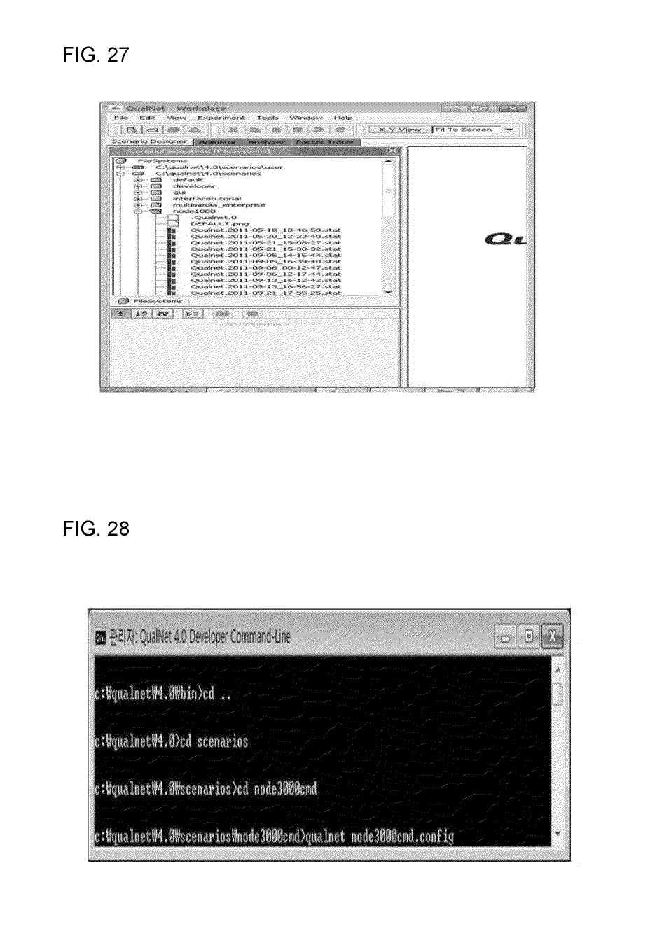

On the screen shown in FIG. 26, it is possible to load the Qualnet scenario file for the simulation as shown in FIG. 27.

As shown in FIG. 27, the screen on which the Qualnet scenario file is loaded is displayed.

If the number of the simulation nodes exceeds 1000, as shown in FIG. 28, the scenario can be executed in the consol mode instead of Qualnet IDE.

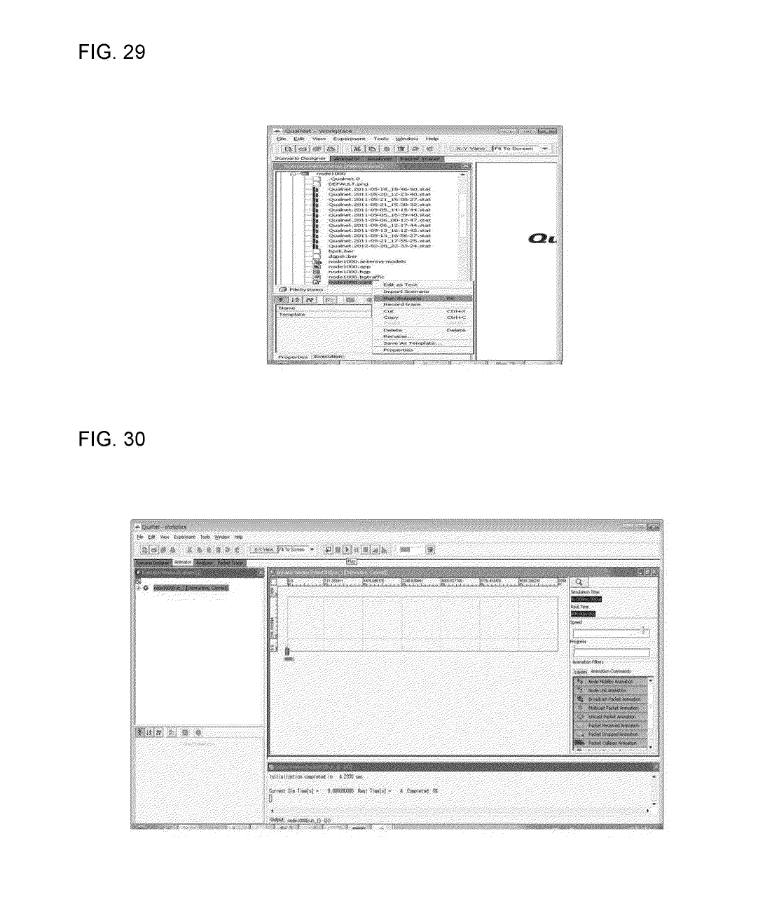

FIG. 29 is a view for describing an execution screen of a Qualnet scenario file.

When the scenario is executed, the button “play” can be clicked as shown in FIG. 30.

(4) Paramics Call-in and Network File Loading

When the traffic communication simulator finishes the Qualnet setting, the Paramics call-in and network files can be loaded in the next step.

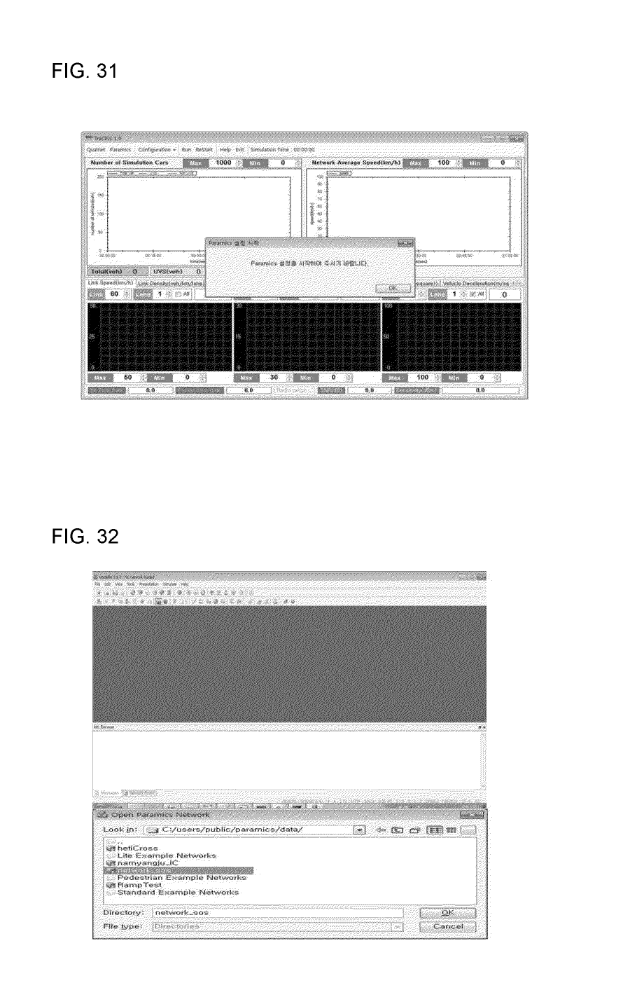

FIG. 31 is a view for describing a call-in screen of Paramics.

As shown in FIG. 31, when the button “OK” is clicked, the Paramics modeler can be called in.

Thereafter, the network files can be loaded from the called-in Paramics modeler.

When the network files are normally loaded, as shown in FIG. 3, the setting path of the Paramics scenario (plug-in) and the status are activated on the screen.

(5) Simulation Configuration Setting

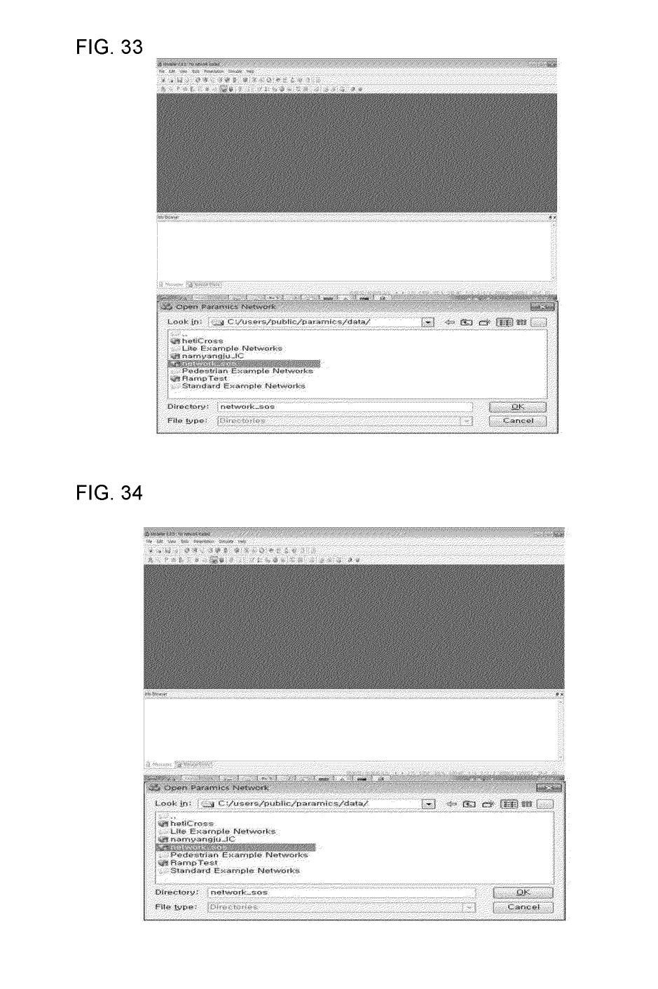

As seen in FIG. 34, the setting screen of the simulation configuration is displayed.

FIG. 34 shows the setting screen of the traffic communication simulation parameter. With the configuration setting parameters, it is possible to set the UVS/UIS data rate, the TX power, the Market ration, the UIS node setting and network setting.

In addition, each parameter can be set by directly inputting bar graphs and numeral values.

(6) Integrated Simulator RUN

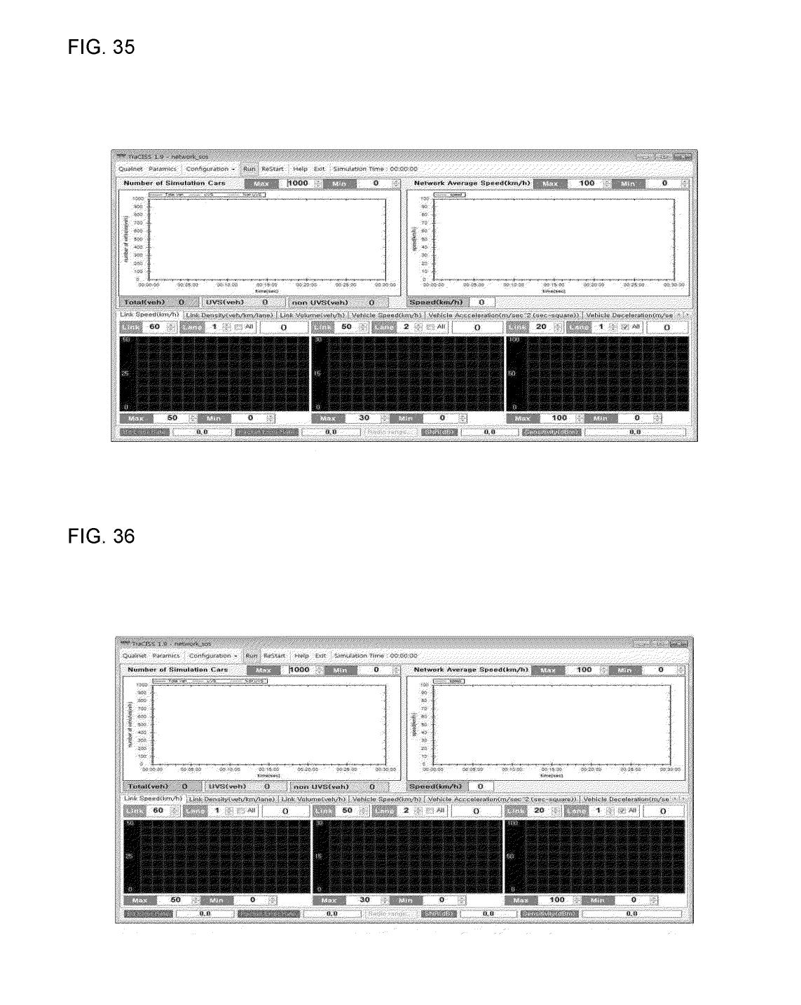

As shown in FIG. 35, when the Configuration setting is finished, the integrated simulation can be performed by clicking the button “RUN” of the upper side of the Main UI.

When the buttons “Pause” or “Restart” is clicked, the simulation can be paused or restarted. Here, the button “Restart” can be used for setting the call-in and scenarios of the Qualnet S/W and the Paramics S/W.

As shown in FIG. 36, the integrated simulator network file setting can be displayed.

As shown in FIG. 36, when the traffic communication-integrated simulator is driven, and the simulation is performed, a corresponding traffic network filename is displayed on the upper side of the main UI.

The lower side of the screen of FIG. 36 shows a result of the communication simulation. The above mentioned result may be displayed at the lower side of the UI window when the whole simulations are finished.

The communication-related MOE are formed of BER, PER, SNR, Sensitivity and the communication radius (Radio-Range). In addition, the five graphs of the middle portion of FIG. 36 display a result of the real time analysis of the traffic simulations.

(7) Example of Traffic Communication Simulations

For any conveniences to the traffic expert who uses the traffic communication-integrated simulator according to an embodiment of the present invention, there are prepared the Paramics S/W network files (including Plug-in scenarios) and the Qualnet S/W scenarios example files.

The Paramics S/W network files (including Plug-in scenarios) list can be checked at C:/Uusers/Public/parmics/data.
network_sos: The mini network which includes a scenario that a vehicle accident occurs in the course that a vehicle runs.
namyangju-IC: Namyangju IC network
Ramptest: Lamp entry guide service-related network
Cross3: Pass priority service-related network at non-traffic signal cross

Qualnet S/W scenario: It can be checked at C:/qualnet/4.0/scenarios
node1000: 802.11A communication method, 1000node, animation mode use scenario
node1000 weather: 802.11A communication method (including weather condition), 1000node, animation mode use scenario
note3000cmd: 802.11A communication method, 3000note, consol mode use scenario
node3000cmd_weather: 802.11A communication method (including weather condition), 3000node, consol mode use scenario

Finally, the present invention has the following effects.

According to an embodiment of the present invention, there is provided a simulation platform which can interface in real time in a synchronous way the traffic simulator (Paramics S/W), the communication simulator (Qualnet S/W) and the Interface Server (including GUI) of the integrated simulator.

According to an embodiment of the present invention, it is possible to obtain an automated simulation in such a way to add a GUI to an integrated simulator for the sake of a user's convenience.

According to an embodiment of the present invention, thanks to the contribution to the automation of the simulation, it is possible to provide a generalized, integrated simulation environment.

According to an embodiment of the present invention, each of the traffic, communication and integrated simulators can be distributed and installed in personal computers and can be operated a network system.

According to an embodiment of the present invention, it is possible to perform a V2V, V2I communication simulation via an actual 802.11A communication network in such a way to transmit in a packet the VID, position, time and transmission data of a vehicle.

According to an embodiment of the present invention, it is possible for a traffic expert to perform a traffic communication-integrated simulation in such a way to use a 802.11A communication network without using professional knowledge.

According to an embodiment of the present invention, it is possible to implement an integrated simulation on which an environment similar with an actual result obtained in the middle of the traffic operation can be reflected by applying a 802.11A actual communication environment including a weather condition, etc.

According to an embodiment of the present invention, it is possible to provide a universal type traffic communication platform on which to perform a traffic communication simulation by directly using a program (C-computer language).

According to an embodiment of the present invention, a modeling with respect to a 802.11A communication hierarchy and propagation environment can be performed, so a traffic communication simulation to which an actual communication environment is applied can be performed.

The method according to the present invention can be implemented in a program command type which can be executed by various computer means and can be stored in a computer-readable recording medium. Here, the computer-readable medium may be formed of a program command, a data file, a data structure and a combination of the same. The program command stored in the medium may be one which is exclusively made for the sake of the present invention or may be one which is known to those who skilled in the computer software field. The computer-readable recording medium may be formed of a hardware device which can store and execute a program command, the hardware device comprising a magnetic media such as a hard disk, a floppy disk and a magnetic tape, an optical medium such as a CD-ROM, a DVD, etc., a magneto-optical medium such as a floptical disk, and a ROM, a RAM and a flash memory. Here, the program command represents a machine language code which is generally made by a compiler as well as a high level language which can be executed by a computer by using an interpreter, etc. The above mentioned hardware device is designed to operate by at least one software module when implementing the operations of the embodiments of the present invention, and vice versa.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims.

Therefore all changes and modifications that fall within the meets and bounds of the claims, or equivalences of such meets and bounds are therefore intended to be embraced by the appended claims.

1. A traffic communication-integrated system, comprising:
a traffic simulator which performs a traffic simulation and calculates a link passage time of a vehicle;
a communication simulator which performs a communication simulation and simulates a communication between a communication between vehicles and a communication between a vehicle and an infrastructure; and
a user interface, and
the user interface including:
an interface server which provides a simulation platform interfacing in real time in a synchronous way the traffic simulator and the communication simulator; and
a graphic user interface unit which outputs a result of the simulations.

2. The system of claim 1, wherein the interface server processes an interface and an integration in a real time synchronous way between the traffic simulator and the communication simulator, and collects a result of the traffic simulation and a result of the communication simulation and processes a data, and processes a protocol with the graphic user interface unit.

3. The system of claim 1, wherein the interface server transmits and receives a simulation parameter, a UIS, a UVS update and a user packet and processes an interface and an integration between the traffic simulator and the communication simulator.

4. The system of claim 1, wherein the interface server performs an exposed measure environment setup and update, and transmits a corresponding result to the graphic interface unit, and receives a user data from the Paramics software, and transmits to a communication environment of the Qualnet S/W and interfaces for the communication simulation to be performed, and when a communication simulation is finished in the Qualnet software, the data of the completion is transferred to the Paramics software, for thereby processing a traffic communication simulation.

5. The system of claim 1, wherein using the interface server GUI program, the graphic user interface unit sets the traffic communication-integrated simulation and monitors the same in real time, and provides a simulation result process module and a display process module, and provides a traffic/communication input condition setting UI, and provides an integrated simulation result display UI, and controls the operations of the traffic/communication simulator.
